(19) United States
(12) Patent Application Publication
(10) Pub. No.: US 2016/0280294 A1
(43) Pub. Date: Sep. 29, 2016

(54) Scalable Modular Recreation Vehicle Platform

(71) Applicant: Baseline RV, LLC, Syracuse, IN (US)

(72) Inventors: Mark Dunithan, Syracuse, IN (US); Mark Lucas, Bristol, IN (US)

(21) Appl. No.: 15/079,510

(22) Filed: Mar. 24, 2016

Related U.S. Application Data
(60) Provisional application No. 62/138,319, filed on Mar. 25, 2015.

(51) Int. Cl. B62D 63/06

(52) U.S. Cl. CPC B62D 63/061

(57) ABSTRACT

The invention comprises a modular recreational vehicle platform comprising a plurality of pods, wherein the pods are joined to each other utilizing a floating tenon system, and wherein the platform comprises a user-selection assortment of pod types and sizes to achieve the desired platform configuration, with pod types including axle pods, mechanical pods, hitch pods, and spacer pods.

### CROSS-REFERENCES TO RELATED APPLICATIONS

This Application is a non-provisional of U.S. Provisional Application No. 62/138,319, Scalable Modular Recreation Platform, filed Mar. 25, 2015, and incorporates the same as if fully set forth herein.

### STATEMENT REGARDING FEDERALLY SPONSORED RESEARCH OR DEVELOPMENT

Not applicable.

### BACKGROUND

The present invention refers to a scalable modular recreation vehicle platform, as shown and disclosed in the included documents, descriptions, and drawings. The platform of the present invention is applicable and useable to a broad array of towable, non-motorized, or motorized vehicles, including but not limited to travel trailers, fifth wheels, motor homes, boats, UTVs, cargo trailers, RVs, and ATVs.

Platforms for such towable, non-motorized, or motorized vehicles known to the art are generally configured as full frames or unibody frames, as would be appreciated by one skilled in the art. Existing platforms are generally made of metal or metal alloys, including primarily steel or aluminum. Existing platforms may be used for a variety of vehicles, however, as would be appreciated by one skilled in the art, such platforms are of fixed configuration and cannot be changed, modified, or customized without imposing significant expense.

### SUMMARY

It is a therefore an object of embodiments of the present invention to provide a modular platform for towable, non-motorized, or motorized vehicles, and most specifically for recreational vehicles, that can be easily scaled, customized, or reconfigured. Such a modular platform system would present a number of cost, labor, and mechanical advantages compared to platforms known to the art.

Those skilled in the art will recognize that many designs and embodiments of the present invention are possible, and that the invention is not limited to the specific embodiments discussed herein.

### BRIEF DESCRIPTION OF DRAWINGS OF A PREFERRED EMBODIMENT

The drawings included herewith depict various modular components of the present invention, as well as a representative, but not exhaustive, display of various configurations of recreational vehicle platform that are achievable through the combination of these modular components. The embodiments shown in the drawings relate to an RV, but it will be readily understood by one skilled in the art that these modular components can be utilized to construct a platform for a number of different vehicle types.

FIG. 1 shows a perspective view of a representative modular vehicle platform according to one embodiment of the present invention;

FIG. 2 shows a side view of a representative modular vehicle platform according to one embodiment of the present invention;

FIG. 3 shows a top view of a representative modular vehicle platform according to one embodiment of the present invention;

FIG. 4 shows an exploded view of a representative first mortise and tenon according to one embodiment of the present invention;

FIG. 5 shows a top view of an axle pod according to one embodiment of the present invention;

FIG. 6 shows a side view of an axle pod according to one embodiment of the present invention;

FIG. 7 shows a top view of a hitch pod according to one embodiment of the present invention;

FIG. 8 shows a top view of a spacer pod according to one embodiment of the present invention;

FIG. 9 shows a top view of a mechanical pod according to one embodiment of the present invention.

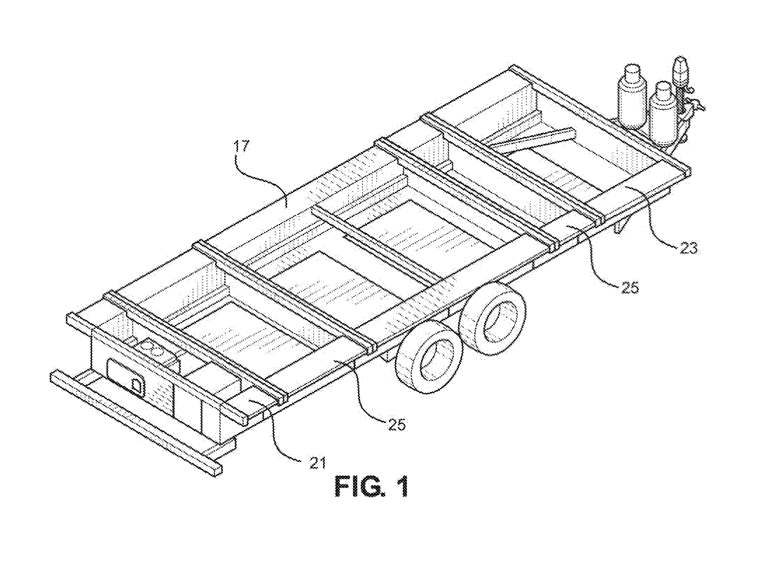

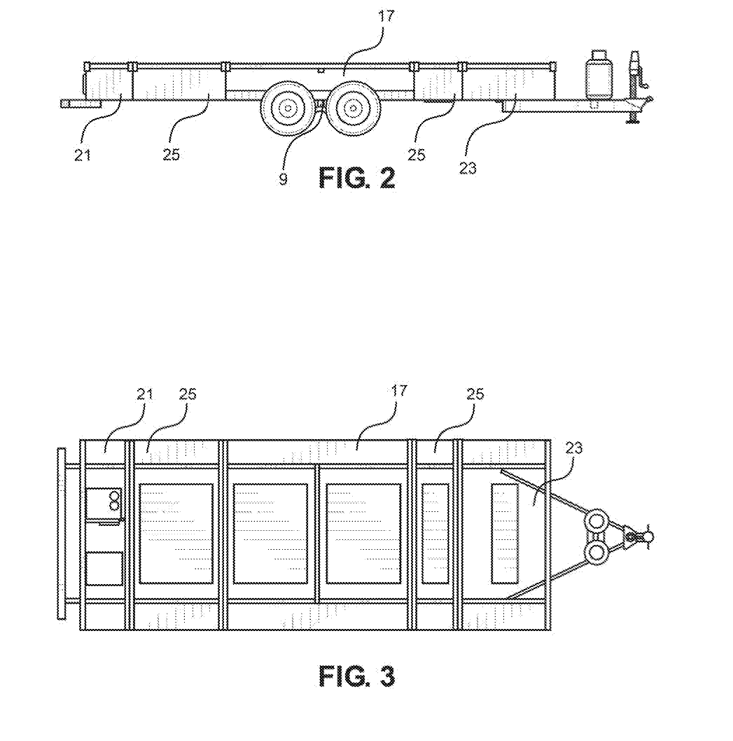

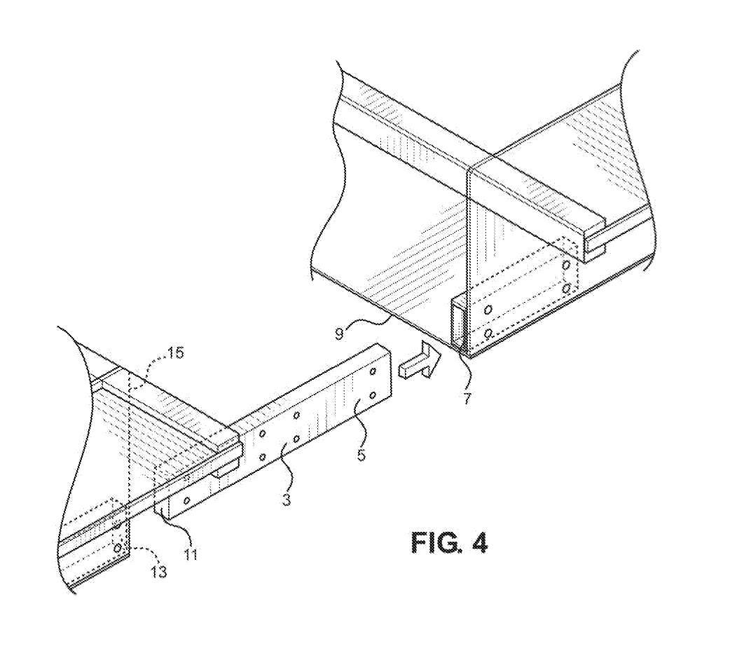

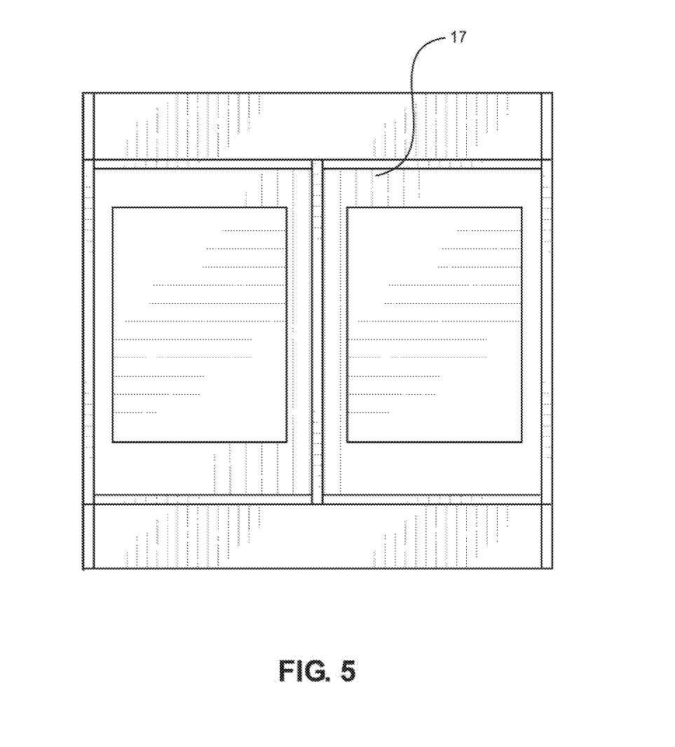

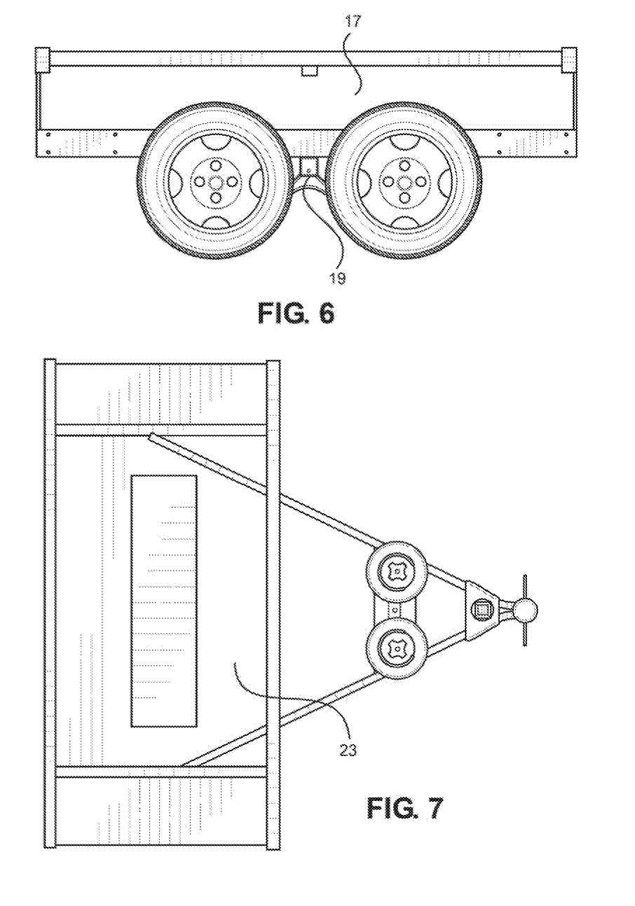

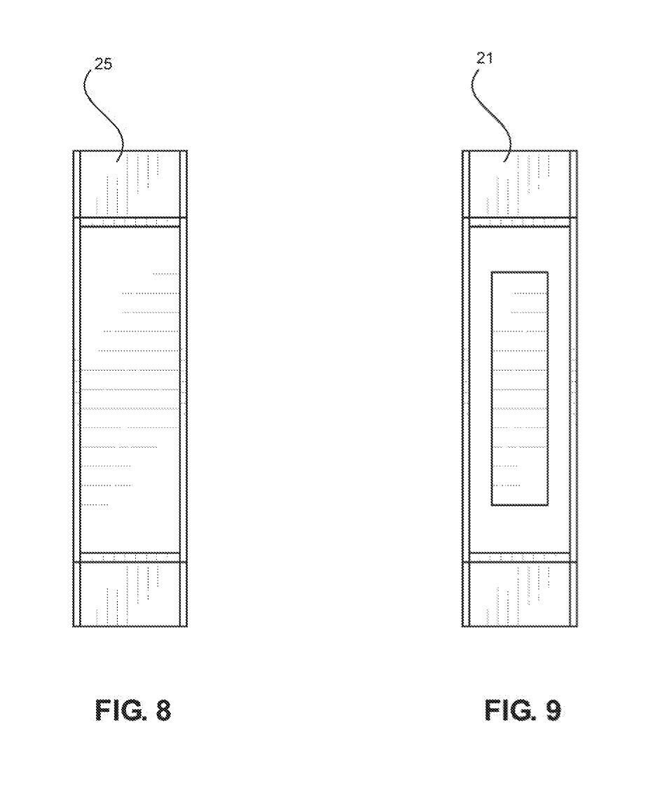

### DETAILED DESCRIPTION

Versions of the present invention are directed to scalable, modular vehicle platform. Vehicle platforms can be constructed within the scope of this invention in an almost infinite variety of sizes, forms, shapes, and functions. Preferably, each modular component, or “pod” (1) of the present invention can be used to construct a vehicle platform for a towable, non-motorized, or motorized vehicle, and preferably a recreational vehicle, of between eighteen and thirty-five feet in length.

The modular pods of the present invention can be constructed of any lightweight material with suitable shear strength, tensile strength, corrosion resistance, dimensional stability, and structural durability. Suitable materials include, but are not limited to, steel and steel alloys, including aluminum. Preferably, the pods of the present invention are constructed of non-metallic materials, resulting in significant weight saving without giving up undue amounts of strength, durability, or stability. Preferred materials include high-strength polymers, more preferably sheet molding composites (or SMCs), and most preferably glass-reinforced, high-strength, structural grade SMC such as 834A1.

Modular pods of preferred embodiments of the present invention each comprise a roughly rectangular section piece of a desired width and length. The pods are joinable to each other and, optionally, designated pods may be joinable to recreational vehicle features such as, but not limited to, axle carriers, A-frame or Reese type hitches, bumpers, wall or floor deck or frame components, wall panels, and floor panels. In embodiments of the present invention, pods are modular and joinable to each other through mechanical connectors such as bolts, nuts, screws, rivets, and other mechanical connectors, as may be appreciated by one skilled in the art. Pods may be configured with pre-drilled holes to accommodate connectors, or may be drilled during fabrication into a frame of desired dimensions. In a preferred embodiment, each pod is configured to contain one or more formed or milled mortises in a first face designed to abut an adjoining pod, and one or more formed or milled mortises in a second face opposite the first face. Mortises of this embodiment may have profiles in a variety of shapes and sizes, including circular, ovoid, square, and rectangular profiles.

Two pods (1) may be joined in this preferred embodiment by fitting a first portion (5) of a tenon (3) into a first mortise (7) on the first face of a first pod, such that a second portion (11) of the tenon (3) extends beyond the first face (9) of the first pod, then fitting the second portion (11) of the tenon (3) into a corresponding second mortise (13) on a second face (15) of a second pod. The tenon (3) is preferably secured to each of the first and second pods through mechanical connectors, such as bolts. The tenon (3) can be made of a variety of materials, including steel and steel alloys, aluminum and its alloys, and high strength polymers such as SMC.

Modularity in this preferred embodiment is achieved by configuring each pod (1) such that each pod (1) has its one or more mortises located at the same relative location, so that any combination of pods may be joined to each other through the above-described floating tenon (3) type connection. In a most preferred embodiment, each pod has three equally spaced mortises on a first face, and three equally spaced mortises on a second face, with the mortises on the first face opposite the mortises on the second face.

Pods may be of solid construction or may optionally be fully or partially hollow. Fully or partially hollow pods may, optionally, be used as underfloor storage space, or may, in the case of a recreational vehicle like an RV or travel trailer, house mechanical components such as water heaters, furnaces, or water pumps.

Pods may be configured in a number of discrete, but modular, sizes and roles. By way of non-limiting example, an “axle pod” (17) is configured to support the weight of the vehicle and is pre-drilled to for mechanical connection to at least one, and preferably two, axle carriers (19). In one embodiment, an axle pod has outer dimensions of 70.5 inches wide by 96 inches long. In another embodiment, an axle pod has outer dimensions of up to 102 inches wide by 96 inches long. For further non-limiting example, a “mechanical pod” (21) may be fully or partially hollow, and may optionally comprise top or bottom access panels, and is configured to house mechanical components such as water pumps, furnaces, or water heaters. A mechanical pod (21) may optionally be pre-drilled with openings or apertures for wires, pipes or conduits, or may be pre-drilled to accept a bumper. In one embodiment, a mechanical pod (21) has dimensions of 70.5 inches by 24 inches long. In another embodiment, a mechanical pod has outer dimensions of up to 102 inches wide by 96 inches long. For further non-limiting example, a “hitch pod” (23) is configured and pre-drilled for attachment to a hitch, such as an A-frame hitch, and is configured to withstand and accept the stresses of pulling the vehicle. In one embodiment, a hitch pod (23) has dimensions of 70.5 inches by 48 inches long. In another embodiment, a hitch pod has outer dimensions of up to 102 inches wide by 96 inches long. For further non-limiting example, a “spacer pod” (25) is configured to expand the overall length of the vehicle. Spacer pods (25) may come in any desired length, although in preferred applications the lengths of spacer pods will be standardized, and multiple spacer pods will be used to achieve desired lengths for larger vehicle platforms. In one embodiment, spacer pods have dimensions of 70.5 inches wide by 24 inches long or 70.5 inches wide by 48 inches long. In another embodiment, spacer pods have outer dimensions of up to 102 inches wide by 48 inches long or up to 102 inches wide by 48 inches long.

A scalable modular vehicle platform according to versions of the present invention may be constructed by joining desired pods together to form a frame with the desired shape, size, and features. In one embodiment, for example, a vehicle platform may be formed by joining a hitch pod (23) to an axle pod (17). In another embodiment, a vehicle platform may be formed by joining a hitch pod (23) to a first mechanical pod (21), joining the first mechanical pod (21) to an axle pod (17), and joining the axle pod (17) to a second mechanical pod (21). In yet another embodiment, a vehicle platform may be formed by joining a hitch pod (23) to a first spacer pod (25), joining the first spacer pod (25) to a first mechanical pod (21), joining the first mechanical pod (21) to a second mechanical pod (21), joining the second mechanical pod (21) to an axle pod (17), joining the axle pod (17) to a second spacer pod (25), and joining the second spacer pod (25) to a third mechanical pod (21). As will be appreciated by one skilled in the art, these examples are illustrative and non-limiting—an almost infinite variety of pods, in various configurations and of various numbers, connected in various ways, can be used to construct a vehicle platform. The characteristics of the vehicle platform constructed according to this invention are limited only by overall size, as a vehicle platform too large may violate applicable traffic laws, and a vehicle too long may additionally begin to suffer degraded overall vehicle strength, stability and safety. Preferably, vehicle platforms constructed according to the teachings of this invention have an overall length of between eighteen and thirty-five feet.

In the pages following and in the enclosed drawings, a number of non-limiting embodiments of vehicle platforms and pods, as well as associated advantages and potential methods or means of connection and construction, are described.

Although the present invention has been described in considerable detail with reference to certain preferred versions thereof, other versions are possible. Therefore, the spirit and scope of the claims should not be limited to the description of the preferred versions described herein.

What is claimed is:

1. A vehicle platform comprising a plurality of modular pods, wherein each pod of the plurality of pods comprises an approximately rectangular platform section, wherein each pod is joined to at least one additional pod, and wherein at least one pod comprises a connection means to a recreational vehicle, and wherein the plurality of pods collectively comprise a platform suitable to comprise the floor of a recreational vehicle.

2. The vehicle platform of claim 1, wherein each pod is joined to at least one additional pod by at least one of a bolt, a nut, a screw, a or rivet.

3. The vehicle platform of claim 2, wherein at least a first pod abuts at least a second pod, wherein said first pod comprises a first face and said second pod comprises a second face opposing said first face, wherein said first face comprises a first mortise and said second face comprises a second mortise, said vehicle platform further comprising a tenon with a first end and a second end, wherein said first end cooperatively engages said first mortise and said second end cooperatively engages said second mortise, joining said first pod and said second pod thereby.

4. The vehicle platform of claim 3, wherein said tenon is connected to at least one of said first mortise and said second mortise by a mechanical connector.

5. The vehicle platform of claim 4, wherein at least one pod is connected to at least one of a wall panel for a recreational vehicle and a floor panel for a recreational vehicle.

6. The vehicle platform of claim 5, wherein at least one pod comprises an axle pod, and said axle pod is configured to support the weight of the vehicle and is pre-drilled to for mechanical connection to an axle carrier.

7. The vehicle platform of claim 6, wherein said first pod comprises three first mortises, said second pod comprises three corresponding second mortises, and said vehicle platform further comprises three tenons, with each of the three tenons cooperatively engaging with a single first mortise and a single corresponding second mortise.

8. The vehicle platform of claim 7, comprising at least one axle pod.

9. The vehicle platform of claim 8, wherein at least one pod comprises a hitch pod, wherein said hitch pod is configured and pre-drilled for attachment to a hitch.

10. The vehicle platform of claim 9, wherein said hitch comprises an A-frame hitch.

11. The vehicle platform of claim 10, wherein at least one pod comprises a mechanical pod, and said mechanical pod comprises a container and at least one access hatch.

12. The vehicle platform of claim 11, wherein said at least one mechanical pod is pre-drilled for apertures suitable for at least one of wires, pipes and conduits.

13. The vehicle platform of claim 11, wherein at least one pod comprises a spacer pod configured to increase the length of the plurality of pods collectively.
